(19) United States
(12) Patent Application Publication
(10) Pub. No.: US 2015/0044633 A1
(43) Pub. Date: Feb. 12, 2015

(54) WATER KIT ASSEMBLY

(71) Applicant: Stoma Ventures, LLC, St. Louis, MO (US)

(72) Inventor: Mark Ellis, Oak Park, MI (US)

(21) Appl. No.: 14/451,358

(22) Filed: Aug. 4, 2014

Related U.S. Application Data
(60) Provisional application No. 61/862,598, filed on Aug. 6, 2013.

(51) Int. Cl. A61C 1/00

(52) U.S. Cl. CPC A61C 1/0084
USPC 433/82

(57) ABSTRACT

A water kit assembly is disclosed which comprises a pouch having a first compartment for storing a volume of water therein and an openable second compartment for storing a tubing therein for connection to the first compartment, a port having a seal extending out of the first compartment into the second compartment, the tubing for insertion into the port and for connection to a dental unit for providing water from the first compartment through the tubing to the dental unit, and an adapter connected to the first compartment, the adapter for being connected to a source of compressed air for facilitating movement of the quantity of water in the first compartment through the tubing to the dental unit.

### RELATED APPLICATION

This application claim priority to U.S. Provisional Patent Application Ser. No. 61/862,598, filed on Aug. 6, 2013, the disclosure of which is incorporated herein by reference.

### BACKGROUND

This disclosure relates to a water kit assembly and more particularly to a disposable water kit assembly that is adapted to provide a supply of sterile water for a dental procedure.

During a dental procedure various motorized hand pieces or dental instruments may be used. For example, a dental instrument may be used to drill into bone or teeth in a mouth of a patient. Drilling generates heat and it is important to be able to reduce or eliminate the heat by supplying a stream of water or fluid. Water is also used to irrigate the mouth of the patient to remove matter or debris from the mouth to allow a dentist to be able to perform a procedure in an unobstructed manner.

A conventional dental or surgical unit may include such items as an air turbine hand piece, a syringe, an operation light, a water supply, a saliva ejector, a high power suction, a foot control pedal, a stool for a dentist, and a chair for a patient. The unit may be fitted with optional accessories such as a fiber optic hand piece, a ultrasonic scaler, and a camera. The air turbine hand piece and the syringe are connected by tubing to a source of compressed air and a source of water. he air pressure may be in the range of about 4.5 to 5.5 Pa and the water pressure may be in the range of about 2 to 4 Pa.

The dental or surgical units are typically connected to a public or utility water supply line that provides water such as tap water. Tap water contamination and the contamination of the tubing that supplies the tap water to the dental units is a safety concern. The American Dental Association Board of Trustees and ADA Council on Scientific Affairs have suggested guidelines for water safety in dental units. In particular, it is suggested that dental equipment that delivers water to patients during nonsurgical dental procedures consistently contained no more than 200 colony-forming units per milliliter (cfu/ml) of aerobic mesophilic heterotrophic bacteria at any point in time in the unfiltered output of the dental unit. It is also recommended that coolant water used in non-surgical dental procedures meet EPA regulatory standards for drinking water, which is less than or equal to 500 colony forming units of heterotrophic bacteria per milliliter of water.

Dental unit waterlines should be maintained and checked on a regular basis to insure that the water being delivered is of an optimal microbiologic quality. Dental unit waterlines consist of tubes that are connected from the water supply to dental instruments such as a high-speed hand piece, an air/water syringe, or an ultrasonic scaler. These waterlines may contain a wide variety of microorganisms such as bacteria, fungi, and protozoans. If these microorganisms go undetected in the waterlines they could cause health issues for some dental patients.

In order to guard against the accumulation of microorganisms in dental waterlines it is important to test or treat the waterlines on a regular, if not daily basis. For example, waterlines may be flushed at the beginning of the day to reduce the microorganisms in the waterlines or the waterlines must be chemically treated. Strict adherence to a maintenance schedule may be required to insure the quality of dental unit water. Further, it may be required to test or monitor the water quality of the waterlines on a routine basis. However, due to time constraints and personnel matters, it may be impractical to maintain and monitor the water quality of supply lines to dental units.

It has also been recommended that sterile solutions such as sterile saline or sterile water should be used during oral surgical procedures. Oral surgical procedures involve the cutting of tissue that exposes the normally sterile areas of the oral cavity. Since dental units do not deliver sterile water, an auxiliary delivery device such as a bulb syringe needs to be used to deliver sterile water during an oral surgery procedure. This may require additional personnel and can be cumbersome in the operating room. Thus, there is a need for a device that can deliver sterile water to dental instruments during an oral surgery procedure.

Therefore, it would be desirable to have a water kit assembly that is disposable and only intended for one time use. It would also be advantageous to have a water kit assembly for a dental unit that is easy to install on and remove from hosing for a source of compressed air. It would also be desirable to have a water kit assembly that includes multiple tubings for connection to various dental instruments to provide a source of sterile water to the dental instruments during a dental procedure or operation.

### BRIEF SUMMARY

In one form of the present disclosure, a water kit assembly comprises a pouch having a first compartment for storing a volume of water therein and an openable second compartment for storing a tubing therein for connection to the first compartment, a port having a seal extending out of the first compartment into the second compartment, the tubing for insertion into the port and for connection to a dental unit for providing water from the first compartment through the tubing to the dental unit, and an adapter connected to the first compartment, the adapter for being connected to a source of compressed air for facilitating movement of the quantity of water in the first compartment through the tubing to the dental unit.

In another form of the present disclosure, a water kit assembly comprises a pouch having a top sheet and a bottom sheet, the top sheet being sealed to the bottom sheet at a top perimeter edge, a first side perimeter edge, a second side perimeter edge, and an intermediate edge to form a first compartment having a quantity of water therein, a quick disconnect adapter connected to the first compartment for connection to a source of compressed air, an openable second compartment for storing a tubing therein for connection to the first compartment, a port having a seal extending out of the first compartment at the intermediate edge into the second compartment, the tubing for connection to the port and a dental unit for providing water from the first compartment through the tubing to the dental unit.

In yet another form of the present disclosure, a water kit assembly comprises a pouch having a top sheet and a bottom sheet, the top sheet being sealed to the bottom sheet at a top perimeter edge, a first side perimeter edge, a second side perimeter edge, and an intermediate edge to form a first compartment having a quantity of water therein, a quick disconnect adapter connected to the first compartment for connection to a source of compressed air, a resealable second compartment for storing a tubing therein, the second compartment formed by an adhesive seal on a bottom side edge, a first side edge, a second side edge, and the intermediate edge of the first compartment, a port having a seal in communication with the first compartment extending into the second compartment at the intermediate edge, the tubing having an outlet end and an opposite sharp end, the sharp end for puncturing the seal of the port for water to flow from the first compartment into the tubing to a dental unit.

The present disclosure provides a water kit assembly that is capable of being used with existing dental instruments and is suitable for one time use and may be discarded after use.

The present disclosure provides a water kit assembly that is easy to install on existing dental equipment and requires little or no modifications to existing dental equipment.

The present disclosure provides a water kit assembly that is small, lightweight, easy to handle, easy to install, and easy to operate.

The present disclosure also provides a water kit assembly which is of simple construction and design and which can be employed with highly reliable results.

The present disclosure is related to a water kit assembly that does not require sterilization and prevents cross-contamination.

The present disclosure further provides a water kit assembly that has a quantity of sterile water that may be used during a dental procedure to provide sterile water to one or more dental instruments.

The present disclosure is related to a water kit assembly that supplies a quantity of sterile water when the previous supply of water has been deemed unacceptable due to contamination or unreliability.

The present disclosure provides a water kit assembly that may be used in emergency situations such as when the water supply is unavailable or for use in the field.

These and other advantages of the present disclosure will become apparent after considering the following detailed specification in conjunction with the accompanying drawings, wherein:

### BRIEF DESCRIPTION OF THE DRAWINGS

FIG. 1 is a perspective view of a water kit assembly constructed according to the present disclosure;

FIG. 2 is a perspective view of another water kit assembly constructed according to the present disclosure;

FIG. 3 is a side view of the water kit assembly shown in FIG. 2 shown in a closed state;

FIG. 4 is a side view of the water kit assembly shown in FIG. 2 shown in an open state with a tubing connected to a port; and

FIG. 5 is a perspective view of another water kit assembly constructed according to the present disclosure.

### DETAILED DESCRIPTION OF PREFERRED EMBODIMENTS

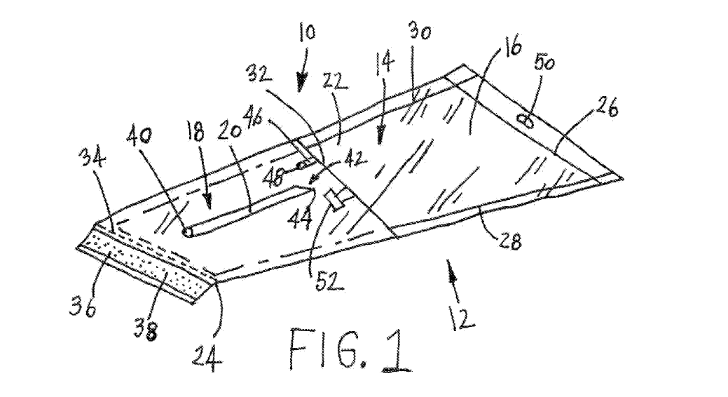

Referring now to the drawings, wherein like numbers refer to like items, number 10 identifies a water kit assembly constructed according to the present disclosure. With reference now to FIG. 1, the water kit assembly 10 comprises a pouch 12 having a first compartment 14 having a quantity of water 16 stored therein and a second compartment 18 having a tubing 20 stored therein. Although the tubing 20 is shown in this view as a section of material, the tubing 20 may have any suitable length and may even be wound up within the second compartment 18. The tubing 20 is connectable to the first compartment 14 and when the tubing 20 is connected it is adapted for delivering water 16 from the first compartment 14 through the tubing 20 to a dental unit (not shown). All that is required of the tubing 20 is that the tubing 20 have a sufficient length so as to connected the first compartment 14 to the dental unit. The quantity of water 16 may be a sterile saline solution or sterile water. Also, for purposes of example only, the quantity of water 16 may be sixteen ounces. However, it is possible that the quantity may be lesser or greater than this quantity.

The pouch 12 may comprise a top sheet 22 of material and a bottom sheet 24 of material that is sealed together along a top perimeter edge 26, a first side perimeter edge 28, a second side perimeter edge 30, and a center or intermediate perimeter edge 32. A bottom perimeter edge 34 may have a flap 36 having a portion of adhesive 38 thereon to seal the top sheet 22 to the bottom sheet 24. In this manner, the flap 36 may be opened to allow the top sheet 22 to be opened relative to the bottom sheet 24 to gain access to the interior of the second compartment 18 to allow an end 40 of the tubing 20 to be removed from the second compartment 18. The tubing 20 may have an end 42 having a spiked or sharp end 44 that may be used to puncture or pierce an administration port 46 associated with the first compartment 18. The port 46 is used to gain access to the contents of the first compartment 14 by puncturing a seal 48 associated with the port 46. The top sheet 22 and the bottom sheet 24 may be formed of a flexible material such as polyester, polyester/polyolefin laminate, or any other suitable plastic material. The top sheet 22 and the bottom sheet 24 may have printing thereon such as instructions. The top perimeter edge 26 may have an aperture 50 that may be used to hang the assembly 10 on a hanger or a mounting bracket (not shown) provided on the dental unit (also not shown). A quick disconnect adapter 52 is provided in the second compartment 18 and is connected to the first compartment 14. The adapter 52 is connected to a source of compressed air (not shown) for facilitating movement of the quantity of water 16 in the first compartment 14 through the tubing 20 to the dental unit. The end 40 of the tubing 20 is adapted to be connected to a hand piece (not shown) associated with the dental unit for providing the water 16 to the hand piece. It is also possible that the second compartment 18 may be fully opened by separating the top sheet 22 from the bottom sheet 24 up to the intermediate perimeter edge 32 thereby exposing the port 46 and the seal 48. Further, although not shown, it is possible that the tubing 20 may include a water volume control valve 42 to control the flow rate of the water 16 from the first compartment 14 through the tubing 20.

In operation of the water kit assembly 10, the flap 36 is opened to gain access to the second compartment 18. The end 40 of the tubing 20 is connected to a dental hand piece or other dental instrument that may use water. The sharp end 44 tubing 20 is then used to puncture the seal 48 associated with the port 46. Water 16 within the first compartment 14 may now flow from the first compartment 14 through the tubing 20 to the dental instrument. A hose (not shown) has one end connected to a source of compressed air and the other end connected to the adapter 52. Compressed air will force movement of the water 16 through the tubing 20. Once the dental procedure or operation is completed, the hose is disconnected from the adapter 52, the tubing 20 is disconnected from the dental instrument, and the assembly 10 may be properly disposed of by any suitable means.

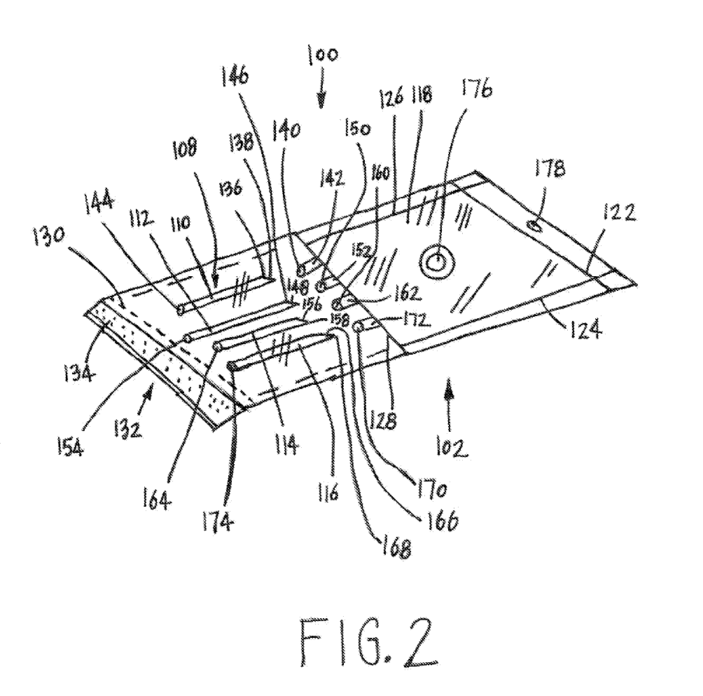

FIG. 2 illustrates a perspective view of another embodiment of a water kit assembly 100 constructed according to the present disclosure. The water kit assembly 100 comprises a pouch 102 having a first compartment 104 having a quantity of water 106 stored therein and a second compartment 108 having four tubings 110, 112, 114, and 116 stored therein. The tubings 110, 112, 114, and 116 may be shorter or longer than is illustrated. The quantity of water 106 may be a sterile saline solution or sterile water. The pouch 102 may comprise a top sheet 118 and a bottom sheet 120 that are sealed together along a top perimeter edge 122, a first side perimeter edge 124, a second side perimeter edge 126, and a center or intermediate perimeter edge 128. A bottom perimeter edge 130 may have a flap 132 having a portion of adhesive 134 thereon to seal the top sheet 118 to the bottom sheet 120 to close the second compartment 108. In this manner, the flap 132 may be opened to allow the top sheet 118 to be opened relative to the bottom sheet 120 to gain access to the interior of the second compartment 108. When the flap 132 is opened, the tubings 110, 112, 114, and 116 may be removed from the second compartment 108.

The tubing 110 has an end 136 having a sharp or pointed portion 138 that is used to pierce or puncture a seal 140 associated with an administration port 142. The tubing 110 has another end 144 which may be connected to a dental instrument. The tubing 112 has an end 146 that has a sharp portion 148 that is used to puncture a seal 150 associated with an administration port 152. The tubing 112 has another end 154 which may be connected to a dental instrument. The tubing 114 has an end 156 that has a sharp portion 158 that is used to puncture a seal 160 associated with an administration port 162. The tubing 114 has another end 164 which may be connected to a dental instrument. The tubing 116 has an end 166 that has a sharp portion 168 that is used to puncture a seal 170 associated with an administration port 172. The tubing 116 has another end 164 which may be connected to a dental instrument. Puncturing the seals 140, 150, 160 and 170 provides for access to the water 106 in the first compartment 104.

A quick disconnect adapter 176 is provided on the top sheet 118 in the area of the first compartment 104. The adapter 176 is connected to a source of compressed air (not shown) for facilitating movement of the quantity of water 106 in the first compartment 104 through any tubing 110, 112, 114, and 116 that has been connected to a respective port 142, 152, 162, or 172. The top perimeter edge 122 may have an aperture 178 formed therein that may be used to hang the assembly 100 on a hanger or a mounting bracket (not shown) provided on the dental unit (also not shown). The top sheet 118 and the bottom sheet 120 may be formed of a flexible material such as polyester, polyester/polyolefin laminate, or any other suitable plastic material. The top sheet 118 and the bottom sheet 120 may have printing thereon such as instructions.

As can be appreciated, the water kit assembly 100 may be used as follows. The flap 132 is opened to gain access to the second compartment 108. The tubings 110, 112, 114, and 116 may be removed from the second compartment 108. The ends 144, 154, 164, and 174 may be connected to a dental hand piece or other dental instrument that may use water. The sharp end 138, 148, 158, and 168 may then used to puncture the seals 140, 150, 160, and 170 associated with the ports 142, 152, 162, and 172. Water 106 within the first compartment 104 may now flow from the first compartment 104 through any of the connected tubings 110, 112, 114, and 116 to the connected dental instrument. A hose (not shown) has one end connected to a source of compressed air and the other end connected to the adapter 176. Compressed air will force movement of the water 106 through any of the connected tubings 110, 112, 114, and 116. Once the dental procedure or operation is completed, the hose is disconnected from the 176, all of the connected tubings 110, 112, 114, and 116 are disconnected from the dental instrument, and the assembly 100 may be disposed or recycled.

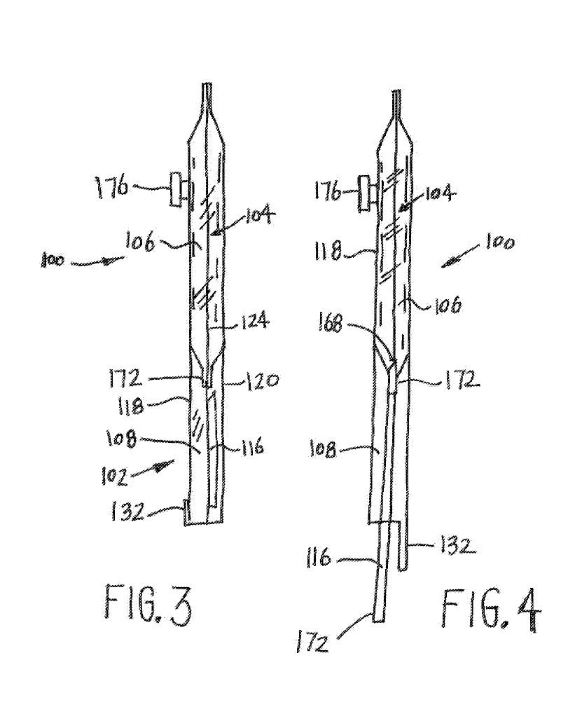

FIG. 3 shows a side view of the water kit assembly 100 in a sealed state prior to use. The water kit assembly 100 is shown with the flap 132 closed, the tubing 116 stored within the second compartment 108 and not attached to the port 172. The adapter 176 is shown extending out from the top sheet 118. The bottom sheet 120 is also shown in further detail. The first side perimeter edge 124 extends the entire length of the pouch 102. The water 106 is shown filled in the first compartment 104.

With reference to FIG. 4, the water kit assembly 100 is shown in an open state with the flap 132 being opened, the sharp portion 168 puncturing into the port 172, and the end 174 of the tubing 116 extending out of the second compartment 108. As has been indicated, the end 174 may be attached to a dental instrument for providing water 106 from the first compartment 104 to the dental instrument. The adapter 176 extends out from the top sheet 118 adjacent to the first compartment 104. As has been indicated, a hose connected to a source of compressed air is connected to the adapter 176 to facilitate the flow of water 106 from the first compartment 104 through one or more of the tubings 110, 112, 114, and 116 to one or more dental instruments for providing the water 106 to a work site such as a mouth of a dental patient.

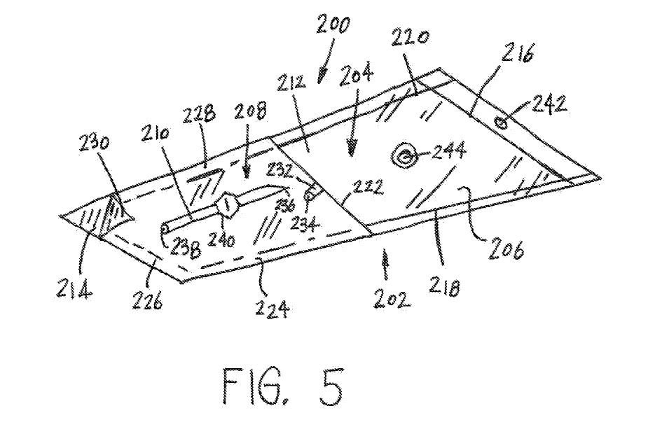

FIG. 5 depicts another embodiment of a water kit assembly 200 constructed according to the present disclosure. The water kit assembly 200 comprises a pouch 202 having a first compartment 204 having a quantity of water 206 stored therein and a second compartment 208 that has a tubing 210 stored therein. Although the tubing 210 is shown in this view as a section of material, the tubing 210 may have any suitable length and may even be wound up within the second compartment 208.

The pouch 202 may comprise a top sheet 212 and a bottom sheet 214 that is sealed together to form the first compartment 204 along a top perimeter edge 216, a first side perimeter edge 218, a second side perimeter edge 220, and a bottom perimeter edge 222. The edges 216, 218, 220, and 222 may be formed by heat sealing. The second compartment 208 is formed by having a releasable adhesive seal formed between a first side edge 224, a bottom side edge 226, and second side edge 228, and the sealed bottom perimeter edge 222 of the first compartment 204. In order to gain access to the second compartment 208, the top sheet 212 is separated or peeled from the bottom sheet 214, along the edges 224, 226, and 228, as is depicted at a corner 230 of the pouch 202.

The second compartment 208 also has an administration port 232 having a seal 234 that may be punctured by a sharp or pointed end 236 of the tubing 210. As has been indicated, by puncturing the seal 234, water 206 contained within the first compartment 204 may flow through the tubing 210 out an outlet end 238 of the tubing 210. The tubing 210 may also have a water volume control valve 240 for controlling the flow of water 206 through the tubing 210 to a dental instrument. Although not shown, it is also contemplated to have one than one tubing 210 and more than one port 232. In this manner, more than one dental instrument may be served by the water kit assembly 200.

The top sheet 212 and the bottom sheet 214 may be formed of a flexible material such as polyester, polyester/polyolefin laminate, or any other suitable plastic material. The top sheet 212 and the bottom sheet 214 may have printing thereon such as instructions. The top perimeter edge 216 may have an aperture 242 formed therein that may be used to hang the assembly 200 on a hanger or a mounting bracket (not shown) provided on the dental unit (also not shown). A quick disconnect adapter 244 is positioned on the top sheet 212 adjacent the first compartment 204. The adapter 244 is connected to a source of compressed air (not shown) for facilitating movement of the quantity of water 206 in the first compartment 204 through the tubing 210 to the dental unit. The end 238 of the tubing 210 is adapted to be connected to a hand piece (not shown) associated with the dental unit for providing the water 206 to the hand piece.

In order to use the water kit assembly 200, the top sheet 212 is separated from the bottom sheet 214 by use of the edges 224, 226, and 228 to gain access to the second compartment 208. The end 238 of the tubing 210 is connected to a dental hand piece or other dental instrument that may use water. The sharp end 236 tubing 210 is then used to puncture the seal 234 associated with the port 232. Water 206 within the first compartment 204 may now flow from the first compartment 204 through the tubing 210 to the dental instrument. A hose (not shown) has one end connected to a source of compressed air and the other end connected to the adapter 244. Compressed air will force movement of the water 206 through the tubing 210. Once the dental procedure or operation is completed, the hose is disconnected from the 244, the tubing 210 is disconnected from the dental instrument, and the assembly 200 is properly disposed.

From all that has been said, it will be clear that there has thus been shown and described herein a water kit assembly which fulfills the various advantages sought therefore. It will become apparent to those skilled in the art, however, that many changes, modifications, variations, and other uses and applications of the subject water kit assembly are possible and contemplated. All changes, modifications, variations, and other uses and applications which do not depart from the spirit and scope of the disclosure are deemed to be covered by the disclosure, which is limited only by the claims which follow.

What is claimed is:

1. A water kit assembly comprising:
a pouch having a first compartment for storing a volume of water therein and an openable second compartment for storing a tubing therein for connection to the first compartment, a port having a seal extending out of the first compartment into the second compartment, the tubing for insertion into the port and for connection to a dental unit for providing water from the first compartment through the tubing to the dental unit; and
an adapter connected to the first compartment, the adapter for being connected to a source of compressed air for facilitating movement of the quantity of water in the first compartment through the tubing to the dental unit.

2. The water kit assembly of claim 1 further comprising a second port having a seal extending out of the first compartment into the second compartment.

3. The water kit assembly of claim 1 wherein the tubing has a pointed end with the pointed end adapted for puncturing the seal of the port.

4. The water kit assembly of claim 1 wherein the tubing further comprises a water volume control valve.

5. The water kit assembly of claim 1 wherein the first compartment has a top perimeter edge, a first side perimeter edge, a second side perimeter edge, and an intermediate perimeter edge with all of the edges being sealed.

6. The water kit assembly of claim 1 wherein the second compartment further comprises a resealable flap that is adapted to be opened to gain access to the tubing stored in the second compartment.

7. The water kit assembly of claim 1 wherein the adapter is a quick disconnect adapter.

8. A water kit assembly comprising:
a pouch having a top sheet and a bottom sheet, the top sheet being sealed to the bottom sheet at a top perimeter edge, a first side perimeter edge, a second side perimeter edge, and an intermediate edge to form a first compartment having a quantity of water therein, a quick disconnect adapter connected to the first compartment for connection to a source of compressed air, an openable second compartment for storing a tubing therein for connection to the first compartment, a port having a seal extending out of the first compartment at the intermediate edge into the second compartment, the tubing for connection to the port and a dental unit for providing water from the first compartment through the tubing to the dental unit.

9. The water kit assembly of claim 8 further comprising a second port having a seal extending out of the first compartment into the second compartment.

10. The water kit assembly of claim 9 further comprising a second tubing for connection to the second port.

11. The water kit assembly of claim 8 wherein the tubing has a pointed end with the pointed end adapted for puncturing the seal of the port.

12. The water kit assembly of claim 8 wherein the second compartment further comprises a resealable flap that is adapted to be opened to gain access to the tubing stored in the second compartment.

13. The water kit assembly of claim 8 wherein the tubing further comprises a water volume control valve.

14. The water kit assembly of claim 8 wherein the quick disconnect adapter extends from the intermediate edge into the second compartment.

15. The water kit assembly of claim 8 wherein the quick disconnect adapter is positioned on the top sheet adjacent the first compartment.

16. A water kit assembly comprising:
a pouch having a top sheet and a bottom sheet, the top sheet being sealed to the bottom sheet at a top perimeter edge, a first side perimeter edge, a second side perimeter edge, and an intermediate edge to form a first compartment having a quantity of water therein, a quick disconnect adapter connected to the first compartment for connection to a source of compressed air, a resealable second compartment for storing a tubing therein, the second compartment formed by an adhesive seal on a bottom side edge, a first side edge, a second side edge, and the intermediate edge of the first compartment, a port having a seal in communication with the first compartment extending into the second compartment at the intermediate edge, the tubing having an outlet end and an opposite sharp end, the sharp end for puncturing the seal of the port for water to flow from the first compartment into the tubing to a dental unit.

17. The water kit assembly of claim 16 further comprising a second port having a seal extending out of the first compartment into the second compartment.

18. The water kit assembly of claim 17 further comprising a second tubing for connection to the second port.

19. The water kit assembly of claim 16 wherein the quick disconnect adapter extends from the intermediate edge into the second compartment.

20. The water kit assembly of claim 16 wherein the quick disconnect adapter is positioned on the top sheet adjacent the first compartment.
